(19) United States
(12) Patent Application Publication
(10) Pub. No.: US 2024/0318627 A1
(43) Pub. Date: Sep. 26, 2024

(54) VERTICAL WIND SPEED ACCELERATION TYPE WIND TURBINE

(71) Applicant: GREEN POWER BY ACCELERATED FLOW RESEARCH LIMITED LIABILITY COMPANY, Kanagawa (JP)

(72) Inventors: Souichirou ASAI, Kanagawa (JP); Kunimitsu SATO, Kanagawa (JP); Norio SEITOKU, Saitama (JP); Yasutaka YOSHIBA, Chiba (JP); Kouji YAMADA, Kanagawa (JP)

(21) Appl. No.: 18/577,670

(22) PCT Filed: Mar. 31, 2022
(86) PCT No.: PCT/JP2022/016509

§ 371 Date: Jan. 8, 2024

(30) Foreign Application Priority Data
Mar. 28, 2022 (JP) 2022-051051

(51) Int. Cl. F03D 3/00; F03D 9/35

(52) U.S. Cl. CPC F03D 3/005; F03D 9/35

(57) ABSTRACT

A wind turbine includes: a collector base; a tunnel body; and a wind turbine. The collector base has an entire circumference at which a wind inflow part is formed. The tunnel body includes a lower front member that is vertically installed on the collector base, that has a substantially rectangular cross-sectional shape, and whose cross-sectional area is reduced linearly or curvilinearly from a wind inlet formed on the collector base side, and an upper member that linearly or curvilinearly expands from a position of the reduced cross-sectional area to the wind outlet at an upper end. The wind turbine is installed at a reduced part of the tunnel body such that an interval between long side parts of the tunnel body is minimum, and a ratio of short side parts and the long side parts of the tunnel body is 1 to 10 times.

### CROSS-REFERENCE TO RELATED APPLICATIONS

This application is national stage application of International Application No. PCT/JP2022/016509, filed on Mar. 31, 2022, which claims the benefit of priority from Japanese Patent Application No. 2022-051051, filed on Mar. 28, 2022.

### TECHNICAL FIELD

The present invention relates to a vertical wind speed acceleration type wind turbine, and relates to a vertical wind speed acceleration type wind turbine that collects wind from all directions, increases a wind speed at a back of the wind turbine and increases the wind speed at an outlet portion of a wind tunnel body, and, as a result, improve rotation efficiency of blades of the wind turbine and increase generated power.

### BACKGROUND ART

In recent years, there has been a demand for prevention of global warming, and there is an urgent need to develop new clean energy. A wind power generation system that does not emit CO₂ is attracting attention as one of the clean energy. However, although wind power generation is currently under development, wind power generation is currently positioned lower as alternative energy for oil. Means for effectively catching wind energy needs to be continuously developed.

Conventionally, as wind energy catching means, wind power generation that uses a lift type propeller-type wind turbine has been the mainstream. The lift type propeller-type wind turbine requires long and large blades (propeller blades), and therefore has a problem that the wind turbine itself becomes large. Furthermore, energy efficiency of the lift type propeller-type wind turbine is around 40%, that is, around 40% of the wind power energy is captured at present. In this regard, theoretical highest efficiency is 59.3% (Betz's law).

The wind power generation wind turbine has been developed according to such a policy that (1) the wind power generation wind turbine includes blades having a large rotation diameter as much as possible, and (2) the wind turbine is large as much as possible, and (3) is installed at a place at which wind blows as much as possible.

However, there is a problem that, in a case where the diameter of the rotation blade is increased to catch wind as much as possible, a support column needs to be made higher, and therefore becomes unstable against strong wind, and, when the wind is too strong, an operation needs to be stopped for fear of breakage, and construction cost is several hundred million yen and is enormous.

Sometimes, when a person passes through a valley between buildings or a shopping arcade, the person may encounter unexpected strong wind. This is because the wind stopped by a wall of a building or the like concentrates on a passable point of the valley or the shopping arcade to travel toward a void. This concentration of wind is considered to be a kind of the Laval nozzle effect. Accordingly, there has been proposed a wind power generation apparatus that includes a wind turbine placed at a center part, that is, in the vicinity of a minimum cross-sectional area of a Laval nozzle having a shape formed by longitudinally connecting duct tubes (Patent Literature 1).

The inventors of the present invention provided a partition wall between an electric fan and a wind turbine, made a hole in the wall surface of the partition wall, blew wind by the electric fan through the hole, placed the wind turbine right behind the hole, and examined the rotational speed of the wind turbine. As a result, to inventors' surprise, it has been found that the rotational speed of the wind turbine became much lower than a case where the wind was directly blown from the electric fan to the wind turbine without providing the partition wall. That is, it has been found that not only the wind that comes from the front and hits the wind turbine, but also the amount of wind that passes from the surroundings of the wind turbine to the back are important for rotation of the wind turbine, and there has been proposed a wind collection type wind turbine that increases power generation efficiency of the wind turbine by blowing a large amount of wind power converged by an outer wind tunnel body of a double structure wind tunnel body to the back of the wind turbine (Patent Literature 2).

The above-described wind collection type wind turbine functions according to the principle described below. Assuming that the speed of air passing through the wind turbine is V, the density is p, and the pressure is P, total energy of the wind per unit volume is (½) pV²+P=constant, and therefore pressure energy of collected air decreases and kinetic energy of the collected air increases. This is rectification (opposite to randomization) of V and P, and therefore a decrease in entropy (S). Accordingly, free energy increases by -TAS (T: temperature). Accordingly, the wind collection type has higher energy efficiency. However, this is the case where a steady flow of the Bernoulli flow tube is assumed. By placing the wind turbine in the steady flow and extracting energy, V at the back of the wind turbine decreases, and P increases. Accordingly, to bring this flow close to the steady flow, it is necessary to increase the speed of a low-speed flow by friction of a high speed flow measured outside the flow tube. In other words, air molecules that are at the back of the wind turbine and whose speed has been reduced by high speed air molecules are pushed out backward (Patent Literature 3).

Furthermore, to push out the air molecules at the back of the wind turbine, it is effective to provide gaps through which wind blows on both sides of the side surface and the upper and lower surface sides of the wind turbine installed inside an intermediate wind tunnel body, and cause the wind having a high wind speed to flow (Patent Literature 4).

### CITATION LIST

### Patent Literature

Patent Literature 1: JP 2008-520900 A
Patent Literature 2: JP 2011-140887 A
Patent Literature 3: JP 6033870 B2
Patent Literature 4: JP 6110455 B2

### SUMMARY OF INVENTION

### Technical Problem

The basic idea of the present invention is Patent Literature 3 and Patent Literature 4. Details thereof will be described below.

When a person passes through a valley between buildings or a shopping arcade, the person often encounters unexpected strong wind. This is because wind stopped by a wall of a building or the like concentrates on a passable point of the valley or the shopping arcade to travel toward a void. Assuming that the density of the passing air is p and the wind speed is V, energy of wind per unit volume is (½) pV²+P=constant and, therefore when the wind is stopped by the wall and the speed becomes 0, the energy is only the pressure, and the air walls with high pressures are produced on the walls on both sides of an inlet of the valley or the like. It is considered that these walls become wind tunnel ducts, and increase the wind speed.

Therefore, as illustrated in FIGS. 19A and 19B, an electric fan 11 (φ=240 mm) and a wind turbine 12 (φ150 mm) were disposed at an interval of approximately 750 mm, guard-shaped wall members 13a and 13b were respectively provided on an outer side of the rim of the inflow inlet of wind of the wind turbine 12, and the rotational speed of the wind turbine 12 in a case where wind was blown from the electric fan 11 was observed. The outer diameter of this wall member 13a is larger than the wind bundle of the electric fan 11, and the outer diameter of the wall member 13b was the wind bundle of the electric fan 11 or less. Furthermore, although not illustrated, the rotational speed was also observed likewise in the case where the wall members were not provided.

As a result, in the case where the wall member 13a was provided (FIG. 19A), the rotational speed of the wind turbine 12 significantly dropped compared to the case where a wall member was not provided. This is because the wind source is the electric fan, only a wind bundle corresponding to the diameter of the blades of the electric fan 11 can be basically obtained, and, therefore when the outer diameter of the wall member is made larger than the wind speed of the electric fan 11, the wind flow to the back of the wind turbine 12 is completely blocked. Furthermore, in the case where the wall member 13b was provided (FIG. 19B), the rotational speed of the wind turbine increased compared to the case where the wall member 13a was provided. It is considered that this is because, in the case where the wall member 13b having the outer diameter equal to or less than the wind bundle of the electric fan 11 is provided, part of the amount of wind flows to the back of the wind turbine, and therefore wind passing through the wind turbine 12 is pulled and increases the speed.

When the wind passes through the wind turbine, energy is deprived, and the wind speed lowers. This means that the temperature lowers in terms of molecular kinematics. The above experiment shows that the lowered energy of the wind flow at the back of the wind turbine is compensated by mixing/friction with the air current having a high wind speed on the outside, that is, having a large dynamic pressure/kinetic energy, and the speed of the wind flow at the back of the wind turbine increases. As a result, it is found that it is important to forcibly 3 push out the wind passing through the wind turbine to the rear of the wind turbine to increase the rotational speed of the wind turbine.

An object of the present invention is to solve the problem of the conventional technique in view of the above circumstances, and provide a vertical wind speed acceleration type wind turbine that collects wind from all directions and increases a wind speed at the back of the wind turbine, increases the wind speed at an outlet portion of a wind tunnel body, and, as a result, improve rotation efficiency of the wind turbine and increases the generated power.

### Solution to Problem

The vertical wind speed acceleration type wind turbine according to the present invention includes: a wind collector base; a wind tunnel body; and a wind turbine, the wind collector base has an entire circumference at which a wind inflow part is formed, the wind tunnel body includes a lower wind tunnel member that is vertically installed on the wind collector base, that has a substantially rectangular cross-sectional shape, and whose cross-sectional area is formed as a cross-sectional area reduced linearly or curvilinearly from a wind inlet formed on the wind collector base side, and an upper wind tunnel member that is formed so as to linearly or curvilinearly expand from a position of the reduced cross-sectional area to the wind outlet at an upper end, and the wind turbine is installed at a reduced part of the wind tunnel body such that an interval between long side parts of the wind tunnel body is minimum, and a ratio of a short side part and the long side parts of the wind tunnel body is 1 to 10 times (claim 1).

According to the present invention, it is possible to provide the vertical wind speed acceleration type wind turbine that collects wind from all directions by providing the wind collector base, supplies the collected wind to the lower wind tunnel member that has the substantially rectangular cross-sectional shape, and whose cross-sectional area is formed as the cross-sectional area reduced linearly or curvilinearly from the wind inlet formed on the wind collector base side, and the upper wind tunnel member that is formed so as to linearly or curvilinearly expand from the position of the reduced cross-sectional area to the wind outlet at the upper end, thereby increases the wind speed at the back of the wind turbine and increases the wind speed at an outlet portion of a wind tunnel body, and, as a result, improve rotation efficiency of the wind turbine and increases the generated power.

Note that the substantially rectangular cross-sectional shape of the wind tunnel body also includes an elliptical shape, other polygonal shapes, and the like having long side parts and short side parts. According to the present invention, the wind tunnel body has the substantially rectangular cross-sectional shape, so that it is possible to effectively push out an air current of the reduced speed at the back of the wind turbine without allowing the wind speed flowing beside the wind turbine to escape to the left and right of the wind turbine compared to a case where the wind tunnel body has a circular shape or a square shape, and recover speed energy of the air currents at the back of the wind turbine.

More specifically, the wind turbine is installed at the reduced part of the wind tunnel body such that the interval between the long side parts of the wind tunnel body is minimum, and the ratio of the short side parts and the long side parts of the wind tunnel body is 1 to 10 times. Consequently, gaps are formed on both sides of the wind turbine, and high-speed air currents blowing through the gaps push out the air current whose energy has been deprived by the wind turbine and whose speed at the back of the wind turbine has been lowered, so that it is possible to effectively recover the speed energy of the air currents at the back of the wind turbine.

According to one aspect of the present invention, the wind collector base has a periphery part of an upper surface at which a vane that guides collected wind to a center part of the wind collector base is provided (claim 2).

According to this one aspect, the wind coming from all directions through the wind inflow part is efficiently collected at the center part of the wind collector base, and is supplied to the wind inlet formed in the lower wind tunnel member of the wind tunnel body without waste.

According to one aspect of the present invention, the wind collector base has an outer circumference at which a rotating body that covers substantially half of the wind inflow part of the wind collector base is provided, and the rotating body has a substantially center part at which a weathervane that has a yaw function is provided (claim 3). According to this one aspect, even when the wind direction changes, the weathervane exerts the yaw function to rotate the rotating body, and the open portion of the rotating body automatically faces the wind direction, so that it is possible to effectively collect the wind.

According to one aspect of the present invention, the upper wind tunnel member includes at an upper end a rim of the wind outlet at which a wind dispersion part is formed (claim 4). According to this one aspect, the wind outside the wind tunnel body is dispersed, a contact area between the wind outside the wind tunnel body and the wind from the inside of the wind tunnel body is increased, the wind inside the wind tunnel body is forcibly pushed out from the wind outlet of the upper wind tunnel member, so that it is possible to improve the amount and the speed of the wind passing through the wind turbine.

Note that the shape of the wind dispersion part is not limited, and the shape of the wind dispersion part is not limited as long as the shape can allow the wind dispersion part to disperse the wind flowing outside the wind tunnel body, increase the contact area between the dispersed wind and the wind flowing out from the wind outlet of the upper wind tunnel member, encourage mixing of the wind, and eventually increase the speed of the outflow wind.

According to the present invention employing the above configuration, the wind coming from all directions and collected by the wind collector base is collected by the wind inlet of the lower wind tunnel member, and the collected wind passes through the lower wind tunnel member, reaches the wind turbine installed at the reduced part having the substantially rectangular cross-section shape, and rotates the wind turbine. At the same time, the high-speed air currents blow through the gaps formed on the both sides of the wind turbine. Furthermore, the high-speed air currents blowing through the gaps on the both sides of the wind turbine push out the air current whose energy has been deprived by the wind turbine and whose speed at the back of the wind turbine has been lowered, and recovers the speed energy of the air currents at the back of the wind turbine.

At the same time, the lower wind tunnel member formed such that the cross-sectional area is reduced linearly or curvilinearly from the wind inlet to the position at which the wind turbine is installed increases the speed of the wind, guides the wind to the wind turbine, increases the amount and the speed of the wind passing through the wind turbine, and supplies the wind to the upper wind tunnel member.

The upper wind tunnel member is formed such that a reduced cross-sectional area expands linearly or curvilinearly from the position at which the wind turbine is installed to the wind outlet. The wind of a lower speed and a higher pressure in the upper wind tunnel member that has been supplied by bringing the wind having been supplied to the upper wind tunnel member and having passed through the wind turbine into contact with a faster air current of a lower pressure blowing through outside the upper wind tunnel member, and mixing, causing friction between, and absorbing the wind and the air current is pulled out from the wind outlet to increase again the amount and the speed of the wind passing through the wind turbine. This action is further promoted by forming a wind dispersion part at the rim of the wind outlet at the upper end of the upper wind tunnel member. The present invention increases the wind speed at the back of the wind turbine by the two-stage acceleration of the wind speed, and thereby improves the rotation efficiency of the wind turbine and increases the power generation efficiency.

### Advantageous Effects of Invention

According to the present invention, it is possible to provide the vertical wind speed acceleration type wind turbine that collects wind from all directions and increases the wind speed at the back of the wind turbine, increases the wind speed at the outlet portion of the wind tunnel body, and, as a result, improves rotation efficiency of blades of the wind turbine and increases the generated power.

Furthermore, by adopting the vertical type of the wind collection type wind turbine, a wind flow flowing inside the wind collection device and a wind flow flowing outside the wind collection device are substantially orthogonal to each other at the outlet portion of the wind collection device, so that wind is pushed out more. This is because a contact portion of the internal and external wind flows becomes larger than that of a horizontal type.

### BRIEF DESCRIPTION OF DRAWINGS

FIG. 1 is a schematic plan view of a vertical wind speed acceleration type wind turbine according to the present invention.

FIG. 2 is a front cross-sectional view of the vertical wind speed acceleration type wind turbine in FIG. 1.

FIG. 3 is a side cross-sectional view of the vertical wind speed acceleration type wind turbine in FIG. 1.

FIG. 4 is a side sectional view different from FIG. 3.

FIG. 5 is a plan view of a wind collector base having an upper surface on which vanes are provided.

FIG. 6 is a plan view of the wind collector base having the outer circumference at which a rotating body and a weathervane are provided.

FIG. 7 is a cross-sectional view taken along line A-A in FIG. 6.

FIG. 8 is a front cross-sectional view of a vertical wind speed acceleration type wind turbine illustrating another embodiment.

FIG. 9 is a plan view of a vertical wind speed acceleration type wind turbine illustrating the another embodiment.

FIG. 10 is a front cross-sectional view of the vertical wind speed acceleration type wind turbine in FIG. 9.

FIG. 11 is a front cross-sectional view of the vertical wind speed acceleration type wind turbine illustrating another embodiment.

FIG. 12 is a plan view of a guide in FIG. 11.

FIGS. 13A, 13B and 13C are front views illustrating examples of star-shaped dispersion parts.

FIG. 14 is a front view of a guard-shaped dispersion part.

FIG. 15 is a side view and a front view of a cutout protrusion dispersion part.

FIG. 16 is a front view of a gear-shaped dispersion part.

FIG. 17 is a front view for describing the size of the star-shaped dispersion part.

FIG. 18 is a front view and a side view of a rectangular dispersion part.

FIGS. 19A and 19B are experimental diagrams of wind turbine efficiency.

### DESCRIPTION OF EMBODIMENTS

Hereinafter, an embodiment of the present invention will be described with reference to the drawings.

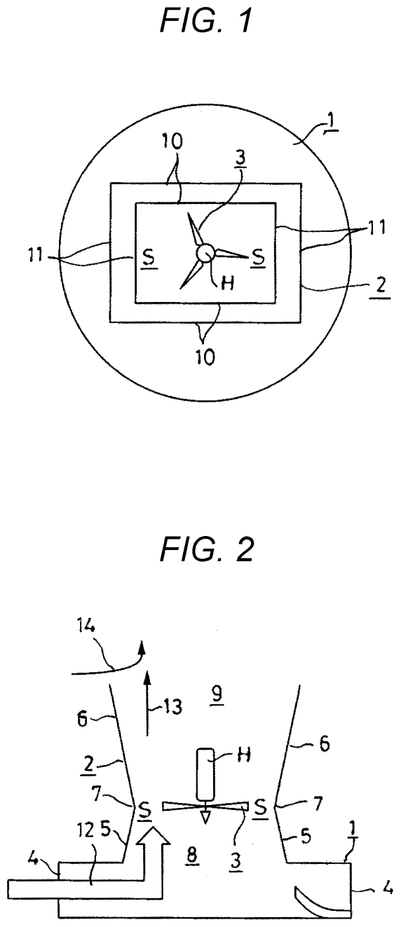

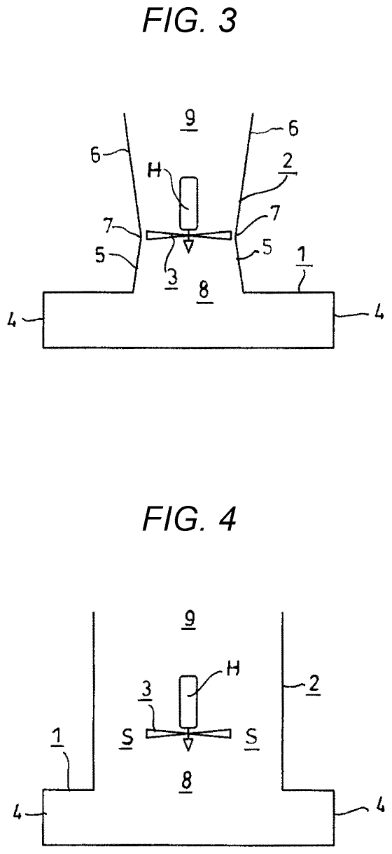

FIG. 1 is a schematic plan view of a vertical wind speed acceleration type wind turbine according to the present invention, FIG. 2 is a front cross-sectional view of FIG. 1, and FIG. 3 is a side cross-sectional view of FIG. 1.

FIGS. 1 to 3 illustrate a wind collector base 1, a wind tunnel body 2, a wind turbine 3, a wind inflow part 4 formed at the entire circumference of the wind collector base 1, a lower wind tunnel member 5 of the wind tunnel body 2, an upper wind tunnel member 6 of the wind tunnel body 2, a reduced part 7 of the wind tunnel body 2, a wind inlet 8 of the wind tunnel body 2, and a wind outlet 9 of the wind tunnel body 2. Furthermore, H represents a generator, and S represents gaps.

The wind collector base 1 is formed in a hollow disk shape, and has the entire circumference at which the wind inflow part 4 is formed. The wind tunnel body 2 includes the lower wind tunnel member 5 that is vertically installed on the wind collector base 1, that has a substantially rectangular cross-sectional shape, and whose cross-sectional area is formed as a cross-sectional area reduced linearly or curvilinearly from the wind inlet 8 formed on the collector base 1 side, and the upper wind tunnel member 6 that is formed so as to linearly or curvilinearly expand from a position of the reduced cross-sectional area to the wind outlet 9 at an upper end, and the lower wind tunnel member 5 and the upper wind tunnel member 6 each have long side parts 10 and short side parts 11.

The wind turbine 3 is installed at the reduced part 7 of the wind tunnel body 2 such that the interval between the long side parts 10 of the wind tunnel body 2 is minimum, and the ratio of the short side parts 11 and the long side parts 10 of the wind tunnel body 2 is 1 to 10 times. As a result, the gaps S are formed on both sides of the wind turbine 3.

Note that an arrow 12 indicates a flow of wind from the wind collector base 1 to the lower wind tunnel member 5, an arrow 13 indicates a flow of wind inside the wind tunnel body 2, and an arrow 14 indicates a flow of wind outside and above the wind tunnel body 2.

FIG. 4 is a side cross-sectional view different from FIG. 3, and illustrates an example where the wind tunnel body 2 is formed as a straight type. Note that, even in a case of this configuration, an unillustrated front cross-sectional view is drawn similarly to FIG. 1 and a reduced part is formed.

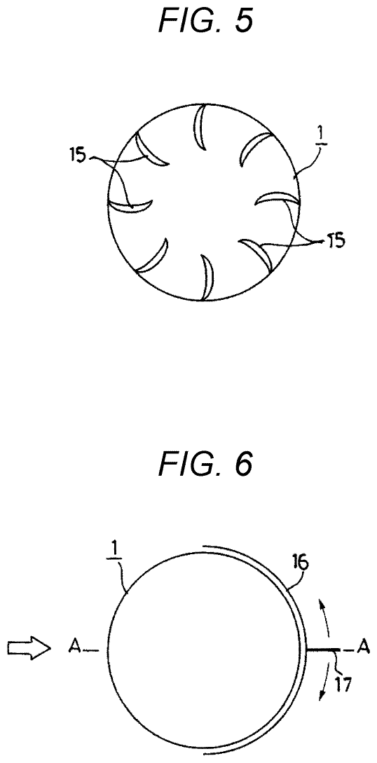

FIG. 5 is a plan view illustrating that vanes 15 that guide collected wind to the center part of the wind collector base 1 are provided at a periphery part of the upper surface of the wind collector base 1. The vanes 15 are curved toward the center part of the wind collector base 1 and consequently can collect wind from all directions at the center part of the wind collector base 1, and the collected wind is supplied to the wind inlet 8 of the lower wind tunnel member 5.

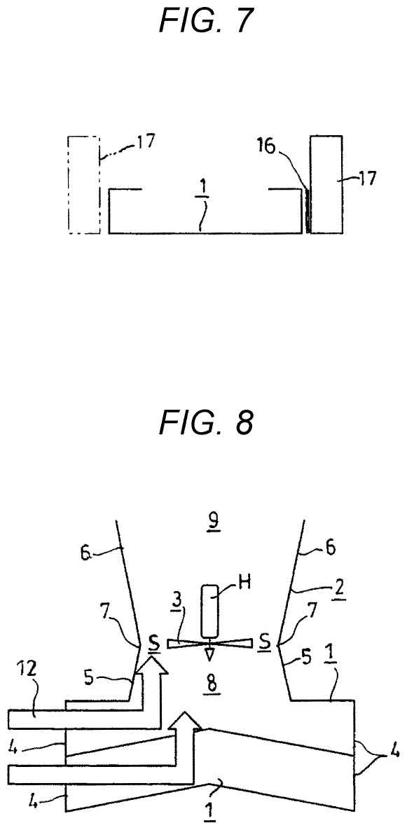

FIG. 6 is a plan view illustrating that a rotating body 16 that covers substantially half of the wind collector base 1 is provided at the outer circumference of the collector base 1, and a weathervane 17 is provided at the substantially center part of the rotating body 16, and FIG. 7 is a cross-sectional view taken along line A-A in FIG. 6. According to this configuration, the weathervane 17 having a yaw function is moved leeward according to a wind direction, and an opening portion of the rotating body 16 faces the wind direction, so that the opening part can effectively collect the wind.

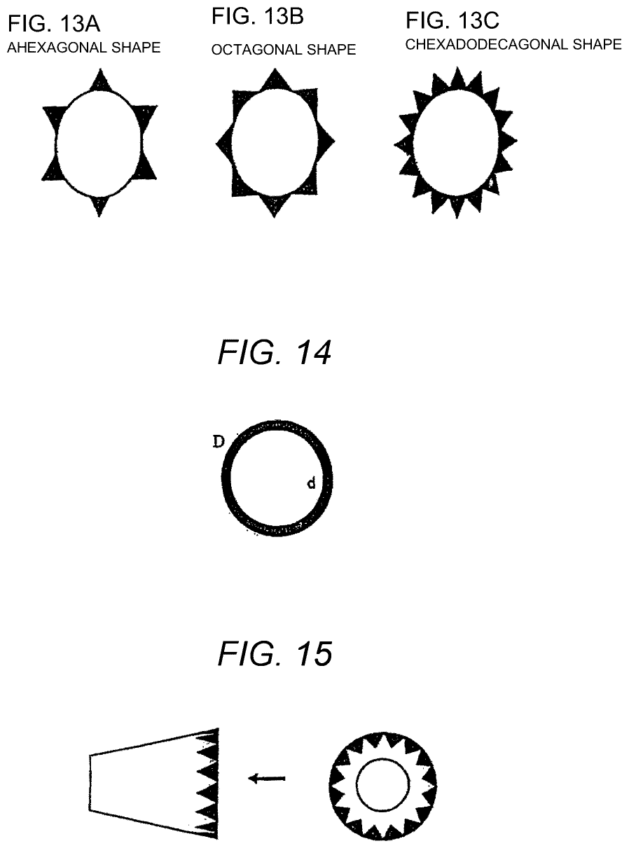

Furthermore, it is preferable to form a wind dispersion part at the rim of the wind outlet 9 of the upper wind tunnel member 6. FIGS. 13A to 18 illustrate examples of the wind dispersion part.

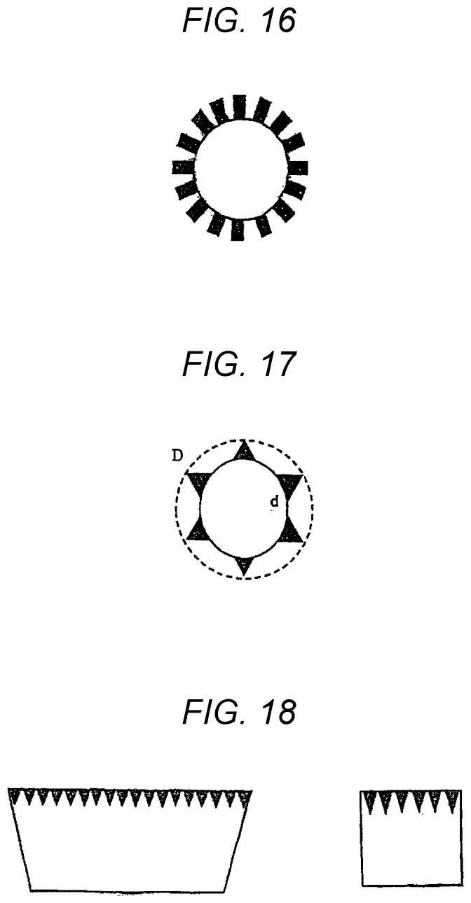

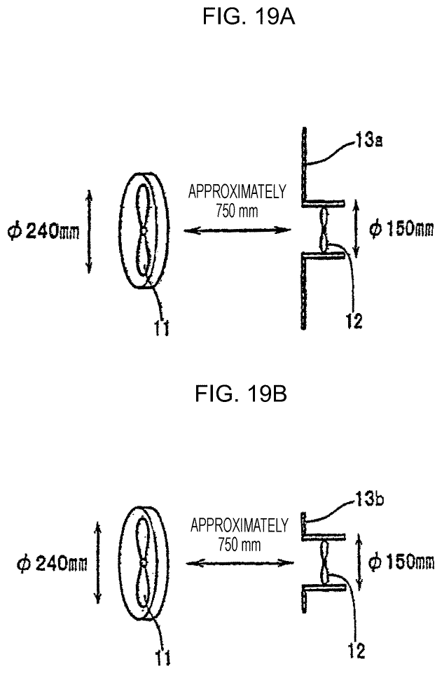

The examples of the dispersion part include star-shaped dispersion parts illustrated in FIGS. 13A, 13B and 13C, a guard-shaped dispersion part illustrated in FIG. 14, a cutout-shaped dispersion part illustrated in FIG. 15, a gear-shaped dispersion part illustrated in FIG. 16, a rectangular dispersion part illustrated in FIG. 18, and the like, yet may be other shapes, and are not limited thereto.

Note that, as illustrated in FIG. 17, an area of a circle drawn by an outer circumferential circle D that connects the outermost parts of a star-shaped dispersion part is preferably twice or more an area of a circle drawn by an outer diameter d of a wind outlet 22b of a wind tunnel body 22.

In FIG. 17, a circle drawn by an outer dotted line is a virtual circle diameter that connects the vertexes of the star-shaped dispersion part, and a circle indicated by an inner solid line is the outer diameter of the wind outlet 9 of the wind tunnel body 2. The area of the star-shaped dispersion part in a circle diameter belt-shaped space sandwiched between the virtual circle diameter D and the outer diameter d of wind outlet is less than approximately half of the area of the other portion.

In the case of the guard-shaped dispersion part in FIG. 14, as illustrated in FIG. 14, the height of the guard is preferably set such that half of the difference between the outer diameter D of the guard and the inner diameter d of the wind outlet 22b is 1/10 to ⅕ of the inner diameter d.

In the case of the cutout dispersion part in FIG. 15, cutouts are not limited to continuous cutouts, and may be provided at intervals, yet the total area of a cutout part is preferably more than half of an area of a surrounding part of the cutouts from a viewpoint of pressure loss in the cutout part.

According to the vertical wind speed acceleration type wind turbine employing the above configuration, the wind coming from all directions and collected by the wind collector base 1 reaches the wind inlet 8 of the lower wind tunnel member 5, further passes through the lower wind tunnel member 5, and rotates the wind turbine 3 installed at the reduced part 7 of the wind tunnel body 2 (arrow 12). At the same time, the high-speed air currents blow through the gaps S formed on the both sides of the wind turbine 3. Furthermore, the high-speed air currents blowing through the gaps S on the both sides of the wind turbine 3 push out the air current whose energy has been deprived by the wind turbine 3 and whose speed at the back of the wind turbine has been lowered, and recovers the speed energy of the air currents at the back of the wind turbine 3 (arrow 13).

At the same time, the lower wind tunnel member 5 formed such that the cross-sectional area is reduced linearly or curvilinearly from the wind inlet 8 to the position at which the wind turbine 3 is installed, guides the wind to the wind turbine 3, and supplies the wind passing through the wind turbine 3 to the upper wind tunnel member 6.

The upper wind tunnel member 6 is formed such that the reduced cross-sectional area expands linearly or curvilinearly from the position at which the wind turbine 3 is installed to the wind outlet 9. The wind of a lower speed and a higher pressure in the upper wind tunnel member 6 that has been supplied by bringing the wind having been supplied to the upper wind tunnel member 6 and having passed through the wind turbine 3 into contact with a faster air current of a lower pressure blowing through outside the upper wind tunnel member 6, and mixing, causing friction between, and absorbing the wind and the air current is pulled out from the wind outlet 9 to increase again the amount and the speed of the wind passing through the wind turbine 3 (arrow 14). This action is further promoted by forming the wind dispersion part at the rim of the wind outlet 9 at the upper end of the upper wind tunnel member 6. The present invention increases the wind speed at the back of the wind turbine 3 by the two-stage acceleration of the wind speed, and thereby improves the rotation efficiency of the wind turbine 3 and increases the power generation efficiency.

FIG. 8 illustrates another embodiment, and is a front cross-sectional view of the vertical wind speed acceleration type wind turbine formed such that the wind collector base 1 is provided at multiple stages (two stages) and the center parts thereof are raised. The same parts as those of the invention will be assigned the same reference numerals. According to this embodiment, it is possible to further improve a wind collecting function of the wind collector base 1.

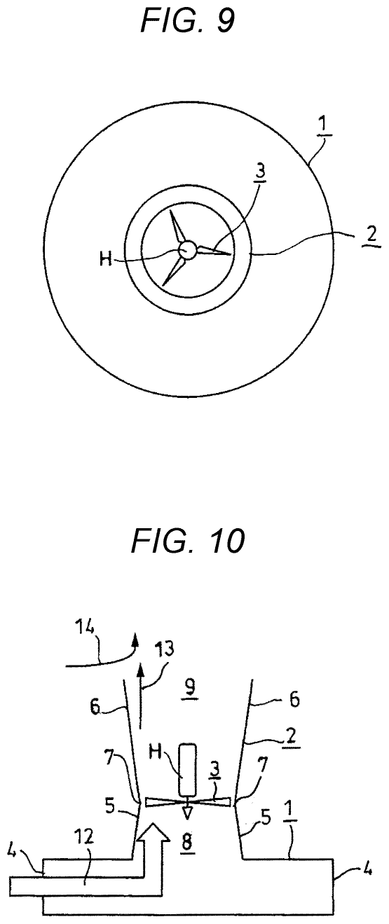

FIGS. 9 and 10 further illustrate another embodiment, and illustrate examples where the wind tunnel body 2 is formed in a cylindrical shape. FIG. 9 is a schematic plan view of the vertical wind speed acceleration type wind turbine, and FIG. 10 is a front cross-sectional view thereof. Note that the side sectional view is the same as the front sectional view in this embodiment. The same parts as those of the invention will be assigned the same reference numerals. In this embodiment, the gaps S are not formed unlike the present invention.

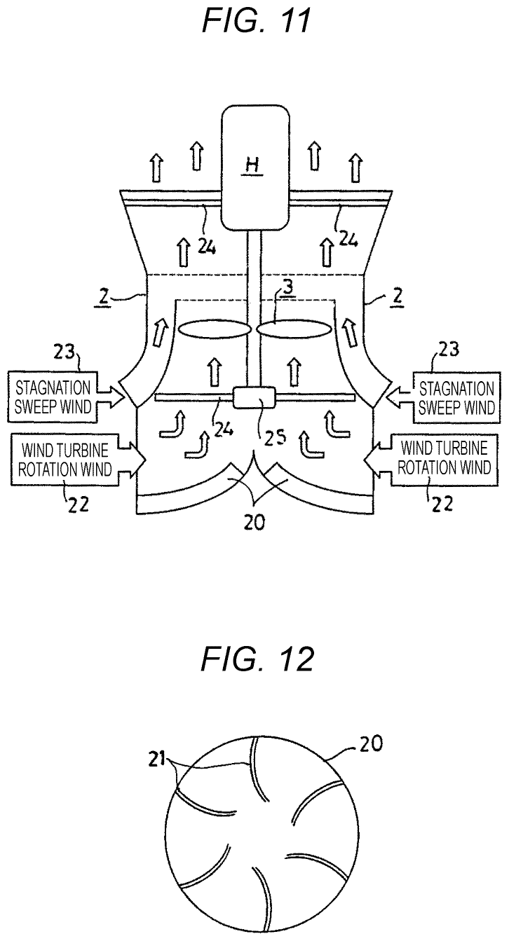

FIGS. 11 and 12 further illustrate another embodiment, and illustrate a structure that the above wind tunnel body structures are disposed at two stages. FIG. 11 is a front cross-sectional view of the vertical wind speed acceleration type wind turbine, and FIG. 12 is a plan view of a guide.

FIGS. 11 and 12 illustrate a guide 20, FIG. 12 is a plan view thereof, and vanes 21 are formed on the upper surface. Furthermore, wind inlets are provided at two stages, lower wind inlets 22 serve as intake ports for wind turbine rotation wind, and upper wind inlets 23 are guided toward an upper side of the wind turbine 3 and serve as intake ports for stagnation sweep wind. FIG. 11 illustrates support bars 24 of the wind turbine 3 and the generator H, and a bearing 25.

In this embodiment, too, the wind turbine 3 is installed at the reduced part 7 of the wind tunnel body 2. Furthermore, in addition to the wind from the intake ports 22 for wind turbine rotation wind, wind of a lower speed and a higher pressure having passed through the wind turbine 3 is brought into contact with faster air currents of lower pressures supplied from the wind intake ports 23 for stagnation sweep wind, and pulled out, so that it is possible to increase the amount and the speed of the wind passing through the wind turbine 3.

### INDUSTRIAL APPLICABILITY

The present invention provides the vertical wind speed acceleration type wind turbine that includes a wind collector base, a wind tunnel body, and a wind turbine, collects wind from all directions and increases a wind speed at the back of the wind turbine, increases the wind speed at the outlet portion of the wind tunnel body, and, as a result, improves the rotation efficiency of blades of the wind turbine and increases the generated power, and is highly advantageous in the field of wind power generation.

1. A vertical wind speed acceleration type wind turbine comprising: a wind collector base; a wind tunnel body; and a wind turbine, wherein the wind collector base has an entire circumference at which a wind inflow part is formed, the wind tunnel body includes a lower wind tunnel member that is vertically installed on the wind collector base, that has a substantially rectangular cross-sectional shape, and whose cross-sectional area is formed as a cross-sectional area reduced linearly or curvilinearly from a wind inlet formed on the wind collector base side, and an upper wind tunnel member that is formed so as to linearly or curvilinearly expand from a position of the reduced cross-sectional area to the wind outlet at an upper end, and the wind turbine is installed at a reduced part of the wind tunnel body such that an interval between long side parts of the wind tunnel body is minimum, and a ratio of a short side part and the long side parts of the wind tunnel body is 1 to 10 times.

2. The vertical wind speed acceleration type wind turbine according to claim 1, wherein the wind collector base has a periphery part of an upper surface at which a vane that guides collected wind to a center part of the wind collector base is provided.

3. The vertical wind speed acceleration type wind turbine according to claim 1, wherein the wind collector base has an outer circumference at which a rotating body that covers substantially half of the wind inflow part of the wind collector base is provided, and the rotating body has a substantially center part at which a weathervane that has a yaw function is provided.

4. The vertical wind speed acceleration wind turbine according to claim 1, wherein the upper wind tunnel member includes a rim of the wind outlet at which a wind dispersion part is formed.
